(19) United States
(12) Patent Application Publication
(10) Pub. No.: US 2012/0324377 A1
(43) Pub. Date: Dec. 20, 2012

(54) USER INTERFACE EXTENSIBILITY FOR WEB APPLICATION DEVELOPMENT TOOL

(75) Inventors: Faith Allington, Bellevue, WA (US); David Anson, Snoqualmie, WA (US); Robert Lucero, Seattle, WA (US)

(73) Assignee: MICROSOFT CORPORATION, Redmond, WA (US)

(21) Appl. No.: 13/161,162

(22) Filed: Jun. 15, 2011

(51) Int. Cl. G06F 3/048

(52) U.S. Cl. 715/763

(57) ABSTRACT

Methods, systems, and computer program products are provided that enable a user interface of a web development tool to be customized for a web application. A plurality of objects that define a web application is received. The objects are determined to include a customization file that includes a definition for at least one user interface element as a customization to a graphical user interface. The customization file is parsed to receive the user interface element definition(s). A graphical user interface is generated for display that is configured to be interacted with by a user to enable the web application to be developed. The graphical user interface includes one or more user interface element based on the user interface element definition(s) as customizations to the graphical user interface.

### BACKGROUND

A web application (also known as a “web app” or “webapp”) is an application that is accessible over a network such as the Internet or an intranet. A web application may be hosted in a common web browser that renders the application. Web applications are becoming popular due to the prevalence of web browsers, and the convenience of using a web browser as a client. The ability to update and maintain web applications without distributing and installing software on potentially thousands of client computers is one reason for their popularity, as is the inherent support for cross-platform compatibility. Examples of web applications include some blogs, webmail, online retail sales, online auctions, wikis and many other functions.

Webapp development software products currently exist that may be used to develop a web application, such as Joomla!® developed by the Joomla Project Team (used to develop websites), and WordPress® (used to develop web blogs). Furthermore, development tools exist that further support the development and the publishing of web applications developed by such webapp development software products. However, current development tools are constrained in terms of user interface flexibility. Currently, a user interface for a web development tool cannot be customized for a particular web application. Instead, users have to write/provide code to provide a customized user interface. This restricts the number of users who can enhance a web application and adds complexity, because the user has to write code, and typically has to compile the code and install it onto a destination computer at which the web application resides to enhance a web application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that enable the customization of user interfaces provided by web development tools for development of web applications. A customization object is provided that defines one or more customizations to the web development tool user interface. The customization object may have a format that specifies the customizations as a list of tasks that are interpretable by the web development tool. The web development tool processes the tasks to customize the web development tool user interface. The customizations to the user interface may include a grouping of items to perform a set of tasks. The customizations aid in making web application development easier by providing user interface elements that are customized for a particular web application, among other benefits.

For instance, in one implementation, a system and method for generating a customization object is provided. A user is enabled to generate a object that includes a definition of at least one user interface element. The user is enabled to include the generated object in a stored plurality of objects. The objects are configured/capable of being loaded and installed by a web development tool as an instance of a web application. The object is configured to be read by the web development tool to display the user interface element(s) as a customization to a graphical user interface displayed by the web development tool. The graphical user interface is configured to be interacted with to enable the web application to be better developed.

In another implementation, a method for customizing a user interface for a web development tool is provided. A plurality of objects that define a web application is received. The objects are determined to include a customization object that includes a definition for at least one user interface element as a customization to a graphical user interface. The customization object is parsed to receive the user interface element definition(s). A graphical user interface is generated for display that is configured to be interacted with by a user to enable the web application to be developed. The graphical user interface is generated to include the user interface element(s) based on the user interface element definition(s) as a customization to the graphical user interface.

In still another embodiment, a web development tool is provided. The web development tool includes a loader, a file parser, and a GUI (graphical user interface) generator. The loader is configured to access a plurality of objects that define a web application. If the objects include a customization object, the loader is further configured to load the customization object, which includes a definition for at least one user interface element as a customization to a graphical user interface. The file parser is configured to parse the customization object to receive the user interface element definition(s). The GUI generator is configured to generate a graphical user interface for display that is configured to be interacted with by a user to enable the web application to be developed. The GUI generator includes the user interface element(s) in the graphical user interface based on the user interface element definition(s) as a customization to the graphical user interface.

Computer program products are also described herein for enabling the customization of graphical user interfaces for web application development tools, and for further embodiments as described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a web application environment, according to an example embodiment.

FIG. 2 shows a block diagram of a customization file, according to an example embodiment.

FIG. 3 shows a block diagram of a graphical user interface (GUI) displayed for a web development tool, according to an example embodiment.

FIG. 4 shows a web development tool GUI, according to an example embodiment.

FIG. 5 shows a version of the web application tool GUI of FIG. 4 that includes customizations provided by a customization file, according to an example embodiment.

FIG. 6 shows a flowchart providing a process for generating a customization file to be used to customize a web development tool GUI, according to an example embodiment.

FIG. 7 shows a block diagram of a customization file creation system, according to an example embodiment.

FIGS. 8 and 9 show block diagrams of editors capable of generating a customization file, according to example embodiments.

FIG. 10 shows a flowchart providing a process for generating a customized web development tool GUI, according to an example embodiment.

FIG. 11 shows a block diagram of a GUI customization system, according to an example embodiment.

FIG. 12 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments relate to techniques for customizing the user interfaces used for development of web applications. Such embodiments enable the user interfaces to be customized on a web application-by-web application basis. Furthermore, as opposed to current techniques, embodiments do not need code to be compiled, or need code to be installed into a global assembly cache or registry. The customization may be provided as a list of tasks that may be interpreted by a web development tool.

Embodiments apply to various types of web applications. For instance, webapp development applications such as WordPress® and Movable Type® (developed by Six Apart of San Francisco, Calif.) enable the development of web blogs. Webapp development applications, including open source content management systems such as Joomla!®, Drupal®, XOOPS® (developed by the XOOPS Project), and TYPO3® (developed by the TYPO3 Association), and enterprise content management systems such as Alfresco® (developed by Alfresco Software, Inc.) enable the development of websites, including blogs. Embodiments enable user interfaces used to develop these and other types of web applications to be customized, including blogs, webmail, online retail sales, online auctions, wikis, and many other types of web applications.

A variety of web development platform tools exist that support the development of web applications, and that have user interfaces that may be customized in embodiments. For instance, Microsoft WebMatrix®, developed by Microsoft Corporation of Redmond, Wash., is a web development tool that enables developers to build web applications capable of running on Microsoft Windows®, Linux®, or other platforms. WebMatrix® includes a bundle of software/tools, integrating a web server (IIS Express) and a database engine (SQL (structured query language) Server Compact), supports code written using ASP.NET or PHP, installs and configures components such as PHP or MySQL, and enables web application publishing. WebMatrix® includes an editor, but also enables integration of available webapp development applications, such as the webapp development applications mentioned herein, and provides the integrated webapp development applications to be used to edit web applications. In another example, Google Web Toolkit™ is a development toolkit developed by Google Inc. of Mountain View, Calif., for building and optimizing complex browser-based applications. Note that WebMatrix® and Google Web Toolkit™ are mentioned herein as examples of web development tools for purposes of illustration, and further types of web development tools exist and/or may be developed that are applicable to the embodiments described herein.

Numerous exemplary embodiments of the present invention are described as follows. It noted that any section/subsection headings provided herein are not intended to be limiting. Embodiments are described throughout this document, and any type of embodiment may be included under any section/subsection.

### II. Example Embodiments

Embodiments provide techniques for customizing user interfaces for web applications. For example, in an embodiment, a customization object such as a customization file may be added to the constituent files and/or other objects of a web application. The customization file may be loaded by a web development tool when loading the web application objects. The customization file may include one or more user interface customizations and/or other types of customizations. The web development tool may modify a user interface of the web development tool according to the user interface customizations. For instance, one or more buttons, menus, links, and/or other user interface elements may be added, removed, and/or modified according to the user interface customizations. Additionally and/or alternatively, the customization file may apply to web development tool aspects other than the user interface. For instance, the customization file may provide an indication of where to store new files for a web application, may indicate a type of image and/or other media object that may be created for the web application, may indicate how web application files may be encoded, may provide information about a database associated with the web application, and/or may provide further information. In this manner, a user experience during development of a web application may be improved.

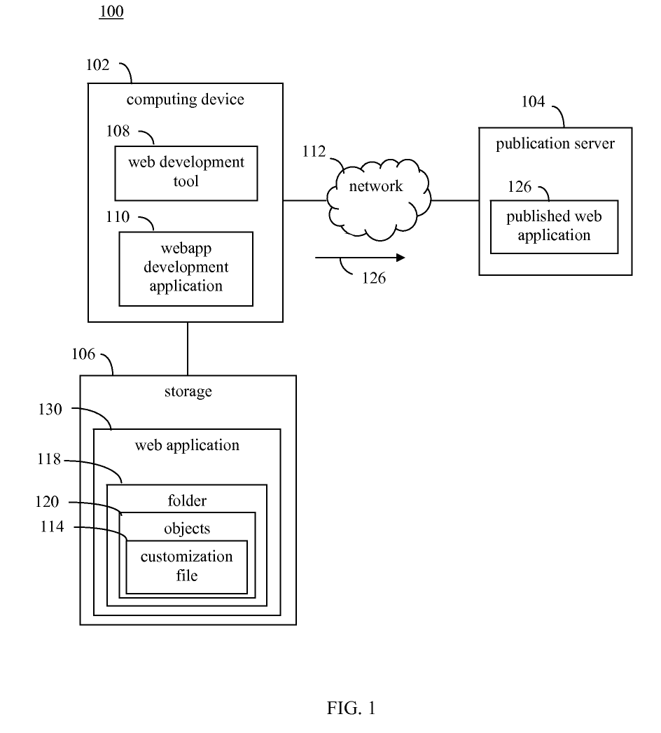

Such embodiments may be implemented in a variety of environments. For instance, FIG. 1 shows a block diagram of a web application environment 100, according to an example embodiment. As shown in FIG. 1, environment 100 includes a computing device 102, a publication server 104, and storage 106. As shown in FIG. 1, computing device 102 includes a web development tool 108 and a webapp development application 110. Environment 100 is described as follows.

Computing device 102 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a mobile phone (e.g., a cell phone, a smart phone such as an Apple iPhone, a Google Android™ phone, etc.), or other type of mobile device. Publication server 104 may be implemented in one or more computer systems, including one or more servers, which may be any type of computing device described herein or otherwise known that is capable of enabling the corresponding functionality described herein.

Computing device 102 and publication server 104 are communicatively coupled by network 112. Network 112 may include one or more communication links and/or communication networks, such as a PAN (personal area network), a LAN (local area network), a WAN (wide area network), or a combination of networks, such as the Internet. Computing device 102 and publication server 104 may be communicatively coupled to network 112 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

A single computing device 102 is shown in FIG. 1 for purposes of illustration. However, any number of computing devices 102 may be present in environment 100, including tens, hundreds, thousands, and even greater numbers of computing devices 102. As shown in FIG. 1, storage 106 is coupled to computing device 102. Storage 106 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Web development tool 108 is a web development tool configured to enable developers to build and publish web applications on various computing platforms, such as one or more of Microsoft Windows®-based computer systems, Linux-based computer systems, etc. For instance, a user of computing device 102 may develop a web application using webapp development application 110 implemented by computing device 102. Webapp development application 110 may be implemented in a browser at computing device 102 (e.g., as a plug-in, add-in, a browser-based editor, etc.), may be made accessible by a browser at computing device 102, or may be implemented separately from a browser at computing device 102. Webapp development application 110 may be a proprietary or commercially available webapp development application such as WordPress®, Movable Type®, Joomla!®, Drupal®, XOOPS®, TYPO3®, etc. Webapp development application 110 may generate a web application 130 by generating a folder 118 in storage 106 that contains objects 120. Objects 120 include a plurality of objects (e.g., files, data, etc.) that make up web application 130. For instance, objects 120 may include servlets, HTML (hypertext markup language) pages (e.g., an “index.html file”, etc.), classes, image files (e.g., .gif files, .jpg files, etc.), XML (extensible markup language) files (e.g., .xml files), PHP files (e.g., .php files), a database such as a MySQL database (e.g., .sql files), and/or further types of objects. Objects 120 may include web application-specific objects.

A user may develop web application 130, generating objects 120, using webapp development application 110, which may or may not be provided by web development tool 108. Web development tool 108 may be invoked to open folder 118 to enable the user to further develop web application 130 and/or to publish web application 130 to a remote server (e.g., as published web application 126 published to publication server 104). For instance, web development tool 108 may generate a user interface. The user interface may include one or more default user interface elements that enable a user to develop and/or otherwise interact with web application 130.

As shown in FIG. 1, a customization object referred to as a customization file 114 may be present in objects 120 of web application 130. Alternatively, customization file 114 may be associated with objects 120 in other ways, such as being stored alongside web application 130 (e.g., stored in a different folder), or being stored remotely from objects 120 and accessible at the remote location by a link or other communication channel associated with objects 120. Customization file 114 includes one or more user interface element customizations and/or other types of customizations that may be applied to the user interface generated by web development tool 108. Because customization file 114 is included in objects 120, customization file 114 provides customizations to the user interface of web development tool 108, and/or to other aspects of web development tool 108, when web application 130 is being developed using web development tool 108. In this manner, a user interface and/or other aspects provided by web development tool 108 may be enhanced, making it easier and/or more convenient for a user that is developing the instance of web application 130 shown in FIG. 1. Furthermore, if web application 130 is copied by making a copy of objects 120 to create one or more additional instances of web application 130, customization file 114 may be copied with web application 130 to each instance. In this manner, the customizations provided by customization file 114 are present when the copies of web application 130 are opened by web development tool 108 (by operating on the copies of objects 120).

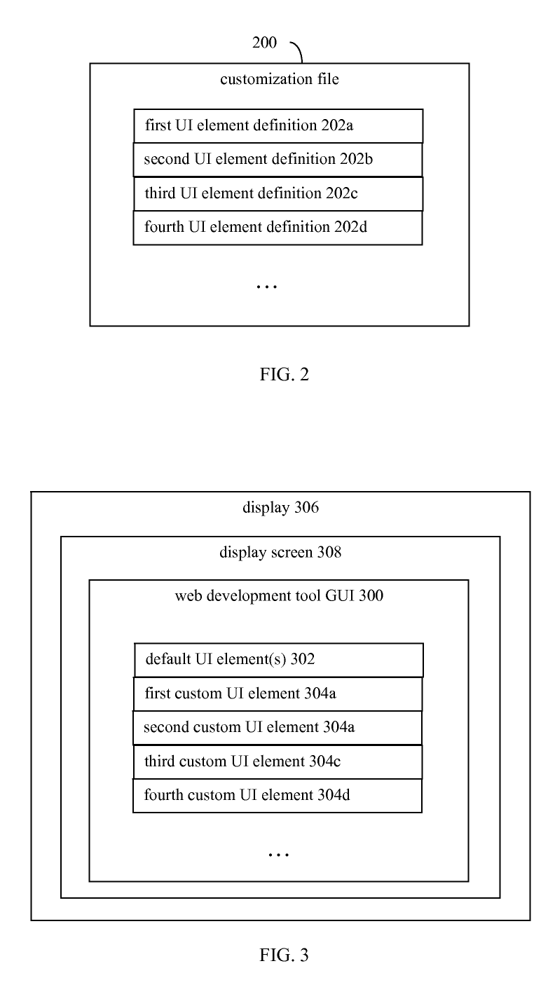

Customization file 114 may have various forms in embodiments, including being another type of object such as table, a list, another type of data structure, etc., and may include content that is arranged in any manner. For instance, FIG. 2 shows a block diagram of a customization file 200, according to an example embodiment. Customization file 200 is an example of customization file 114 of FIG. 1. Customization file 200 may have any form, and may contain information formatted according to any format, including as a markup language or programming language. For instance, in an embodiment, customization file 200 may contain information in the form of XML code, other web standard markup language code, or other type of code (e.g., HTML (hypertext markup language, PHP code, JavaScript, Java code, etc.). In other embodiments, customization file 200 may include information in other forms.

As shown in FIG. 2, customization file 200 includes first-fourth user interface (UI) element definitions 202a-202d. Each of first-fourth UI element definitions 202a-202d is a definition for a corresponding user interface element that is a customization to a graphical user interface provided by web development tool 108. Although four UI element definitions 202a-202d are shown in FIG. 2, any number of UI element definitions 202 may be present in embodiments, including ones, tens, and even greater numbers of UI element definitions 202. Each UI element definition 202 may be implemented in any manner, including as a markup language (e.g., XML, HTML, etc.) or other type of program code (e.g., PHP code, JavaScript, Java code, etc.). Furthermore, although not shown in FIG. 2, further types of customizations may be indicated in customization file 200, including customizations mentioned elsewhere herein.

In an embodiment, when web development tool 108 of FIG. 1 loads web application 130 by loading one or more of objects 120 of folder 118, web development tool 108 loads customization file 114. Web development tool 108 modifies its displayed graphical user interface according to each UI element definition 202 that is present in customization file 114. For instance, FIG. 3 shows a block diagram of a web development tool graphical user interface (GUI) 300 displayed in a display screen 308 of a display 306, according to an example embodiment. For instance, display 306 may be a display associated with computing device 102 of FIG. 1. GUI 300 is an example of a GUI that may be provided by web development tool 108 to enable a user to interact with a web application. Web development tool 108 may load customization file 200 when loading web application 130 of FIG. 1, may load customization file 200 at a later point in time, or may load customization file 200 at a time of user selection (e.g., by interacting with a user interface), and may generate GUI 300 in response. A user may select to load a portion or all of the provided customizations of customization file 200 (e.g., a simple set of customizations, a complex set of customizations, etc.). As shown in FIG. 3, GUI 300 includes default UI element(s) 302. Default UI element(s) 302 includes one or more UI elements that may be displayed in a GUI generated by web development tool 108 by default. Examples of UI elements that may be included in default UI element(s) 302 include windows, menus (e.g., pull down menus, drop down lists, etc.), buttons (e.g., radio buttons), check boxes, text entry boxes, tabs, ribbons, links, navigation elements (e.g., folders, etc.), etc.

Furthermore, as shown in FIG. 3, GUI 300 includes first-fourth custom UI elements 304a-304d, which corresponds to first-fourth UI element definitions 202a-202d of customization file 200 in FIG. 2. First-fourth custom UI elements 304a-304d are custom UI elements that may be displayed in a GUI generated by web development tool 108. Each of first-fourth UI element definitions 202a-202d is used by web development tool 108 to generate a corresponding one of first-fourth custom UI elements 304a-304d. For instance, web development tool 108 may read first UI element definition 202a of customization 200 to generate first custom UI element 304a, may read second UI element definition 202b of customization 200 to generate second custom UI element 304b, etc. Each custom UI element 304 may be used to modify the GUI generated by web development tool 108 in various ways, including by adding a new UI element, deleting a UI element, or modifying an existing UI element.

Although four custom UI elements 304a-304d are shown in FIG. 3, any number of custom UI elements 304 may be present in embodiments, depending on the number and type of UI element definitions 202 listed in customization file 200. Examples of UI elements that may be included in custom UI element(s) 304 include windows, menus (e.g., pull down menus, drop down lists, etc.), menu entries, buttons (e.g., radio buttons), check boxes, text entry boxes, tabs, ribbons, links, navigation elements (e.g., folders, etc.), protection settings, etc. Each custom UI element 304 may optionally have a name for the custom UI element and/or a description of the UI element that is/are provided in the corresponding UI element definition 202, either or both of which may or may not be displayed in the GUI for the custom UI element. Furthermore, each custom UI element 304 may optionally have an associated action (e.g., a command) defined in the corresponding UI element definition 202. The action may be performed if a user interacts with the custom UI element 304 in the GUI.

Example embodiments are further described in the following subsections. For instance, the next subsection describes example embodiments for customization file 200 of FIG. 2 and example custom GUIs, followed by a subsection that describes example embodiments for creating customization files, and a subsection that describes embodiments for modifying GUIs according to customization files.

### A. Example Embodiments for Customization Files and Customized GUIs

As described above, customization file 200 of FIG. 2 may have various forms. For instance, in one example of the contents of customization file 200 are shown below for purposes of illustration:

```
<?xml version=“1.0” encoding=“utf-8”?>
<WebDevelopmentTool>
    <Configure>
      <AddDashboardItem
          Title=“Product help”
          Description=“Click this button to go to the product help page.”
          Uri=“http://www.mywebapp.com/producthelp”/>
      <AddRibbonGroup
          Label=“MyApplication Links”>
          <AddRibbonButton
            Label=“Click this button for help setting up
            MyApplication.”
            Uri=“http://www.mywebapp.com/appsetup/”/>
          <AddRibbonButton
            Label=“Click this button for help customizing
            MyApplication.”
            Uri=“http://www.mywebapp.com/appsetup/”/>
      </AddRibbonGroup>
      <FileProtection>
          <ProtectPath Path=“/Core”/>
          <ProtectPath Path=“/AppData”/>
          <UnprotectPath Path=“/UserData”/>
      </FileProtection>
    </Configure>
</WebDevelopmentTool>
```

The above example contents of customization file 200 may be provided in an XML document (e.g., XML version 1.0) for customization file 200. Furthermore, the above example of customization file 200 is configured to be loaded by a web development tool indicated as “WebDevelopmentTool”.

In the above example, several GUI customizations are provided by corresponding custom UI element definitions in a section indicated for customizations as “Configure”. The GUI customizations include a first custom UI element definition indicated as “AddDashboardItem”, a second custom UI element definition indicated as “AddRibbonGroup”, and a third custom UI element definition indicated as “FileProtection”.

The first custom UI element definition for “AddDashboardItem” is a definition for a UI element to be added to a dashboard space of the web development tool GUI. As indicated above, the first custom UI element definition for “AddDashboardItem” has a name or title of “Product help” and a description of “Click this button to go to the product help page” that are displayed in the GUI. The title and description are selectable as a link in the GUI, and a URI (uniform resource indicator) is provided in the first custom UI element definition of “http://www.mywebapp.com/producthelp” that is traversed as an action if the title/description are interacted with (e.g., clicked on) by a user in the GUI.

The second custom UI element definition for “AddRibbonGroup” is a definition for a UI ribbon group element that is to be added to a ribbon space of the web development tool GUI. As indicated above, the second custom UI element definition for “AddRibbonGroup” has a name or label of “MyApplication Links” and includes first and second added buttons. The first button has a label of “Click this button for help setting up MyApplication” and a URI of “http://www.mywebapp.com/appsetup/” that is traversed as an action if the first button is interacted with by a user. The second button has a label of “Click this button for help customizing MyApplication” and a URI of “http://www.mywebapp.com/appsetup/” that is traversed as an action if the second button is interacted with by a user.

The third custom UI element definition for “FileProtection” is a definition for protections to be provided to directories and/or individual files displayed in a file navigation UI element in the GUI of the web development tool. For instance, the file navigation UI element may show one or more folders in a directory structure, and the files contained therein, and the folders may be expandable and/or collapsible. The “FileProtection” custom UI element definition may enable protections to be provided and displayed for the folders and files. For instance, as indicated above, the third custom UI element definition indicates that protection is to be applied to folder/files of a “Core” directory, as indicated by the “ProtectPath” protection indication. The third custom UI element definition indicates that protection is to be applied to folder/files of an “AppData” directory, as indicated by the “ProtectPath” protection indication. Furthermore, the third custom UI element definition indicates that protection is not to be applied to folder/files of a “UserData” directory, as indicated by the “UnprotectPath” protection indication.

Note that this example of customization file 200 is provided for purposes of illustration, and is not intended to be limiting. Any number and type of custom UI element definitions may be provided in various embodiments of customization file 200, as would be apparent to persons skilled in the relevant art(s) from the teachings herein. Further types of custom UI element definitions may be provided for any type of custom UI element, such as windows (e.g., AddWindow), menus (e.g., AddPulldownMenu), check boxes (e.g., AddCheckBox), text entry boxes (e.g., AddTextBox), menu entries (e.g., AddMenuEntry), a new ribbon (e.g., AddNewRibbon), tabs (e.g., AddTab), etc. Each custom UI element definition may include any number of features described above or otherwise known, such as names/labels, descriptions, actions, etc.

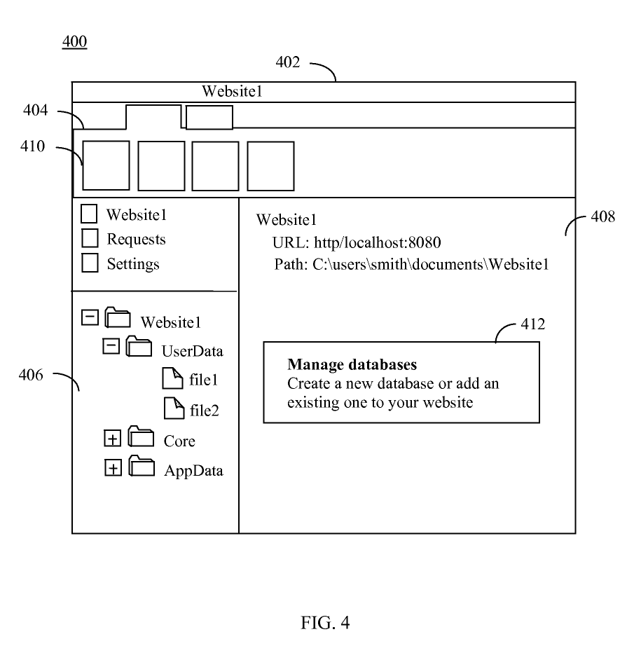

Web development tool 108 (FIG. 1) may generate any type of GUI, including any number and arrangement of user interface elements, as desired for a particular application. For instance, FIG. 4 shows a web development tool GUI 400, according to an example embodiment. GUI 400 is an example of GUI 300 of FIG. 3 without customizations. As shown in FIG. 4, GUI 400 includes a window 402 (labeled “Website1”) that includes a ribbon 404, a directory pane 406, and a dashboard region 408. In the example of FIG. 4, window 402 is rectangular in shape, and ribbon 404 is positioned near and along a topmost or Northern edge of window 402. Directory pane 406 is located below ribbon 404, and along a left or Western edge of pane 406. Dashboard region 408 is located below ribbon 404 and to the right of directory pane 406, and along a right or Eastern edge of pane 406.

Ribbon 404 is a user interface element that includes a set of toolbars places on tabs in a tab bar. Any number of tabs may be present. As shown in FIG. 4, ribbon 404 includes a plurality of buttons 410. Each button of buttons 410 has a corresponding action that may be performed if the button is interacted with by a user.

Directory pane 406 includes a hierarchical tree of folders, where each folder may store respective files and/or additional folders. Each folder displayed in directory pane 406 may be selected to display any files/folders stored therein, and each file may be selected to open the file. In the example of FIG. 4, a top level folder labeled “Website1” is shown, which contains the folders “UserData,” “Core,” and “AppData” as subfolders. The folder “UserData” includes a first file “filer” and a second file “file2.”

Dashboard region 408 indicates a URL for a website being developed (e.g., URL: http/localhost:8080) and a path to the website files (e.g., C:\users\smith\documents\Website1). Furthermore, dashboard region 408 includes one or more interactive items. For instance, dashboard region 408 includes a dashboard item 412, which functions similarly to a button. Dashboard item 412 includes a title “Manage databases” and a description “Create a new database or add an existing one to your website.” If dashboard item 412 is interacted with (e.g., clicked on), the web development tool may navigate to a link associated with dashboard item 412. For instance, the web development tool may open a web page in a browser corresponding to the link.

In embodiments, a customization file may be read by the web development tool when opening a web application to cause customizations to be provided to the web development tool GUI.

For instance, web development tool 108 of FIG. 1 may open folder 118 corresponding to a web application labeled Website1, and may open a customization file 114 provided in objects 120 for the web application. A default GUI for web application Website1 may be GUI 400 shown in FIG. 4. Due to a customization file being present, web development tool 108 may perform customizations to GUI 400. For instance, web development tool 108 may receive the above example customization file to perform customizations to GUI 400 as shown in FIG. 5. FIG. 5 shows a customized web application tool GUI 500, according to an example embodiment, which is a customized version of GUI 400 shown in FIG. 4. GUI 500 is generally similar to GUI 400 of FIG. 4, with differences based on the above example customization file described as follows.

As shown in FIG. 5, ribbon 404 includes a new ribbon group element 502 generated according to the above-described custom UI element definition “AddRibbonGroup” with label “MyApplication Links.” As shown in FIG. 5, ribbon group element 502 includes a first button 506 and a second button 508. Although not shown in FIG. 5 for ease of illustration, first button 506 may have a label of “Click this button for help setting up MyApplication” and an associated URI of “http://www.mywebapp.com/appsetup/” that may be traversed as an action if first button 506 is interacted with by a user, and second button 508 may have a label of “Click this button for help customizing MyApplication” and an associated URI of “http://www.mywebapp.com/appsetup/” that may be traversed as an action if second button 508 is interacted with by a user.

Dashboard region 408 includes a new dashboard item element 504 generated according to the above-described custom UI element definition “AddDashboardItem” with title “Product help” and description “Click this button to go to the product help page.” If dashboard item element 504 is interacted with (e.g., clicked on), the web development tool may navigate according to the link “http://www.mywebapp.com/producthelp” that is associated with element 504 as an action.

Directory pane 406 includes new protections provided to directories and/or individual files generated according to the above-described UI element definition “FileProtection.” As shown in the example of FIG. 5, the folder “UserData” and its contents (file1 and file2) are shown unchanged, being unprotected. In contrast, the folders “Core” and “AppData” are shown with graphical UI protection elements 510 (e.g., miniature “lock” symbols) that indicate that “Core” and “AppData” are protected folders (e.g., are protected from being edited within web development tool by users).

As such, customizations to a web development tool GUI may be provided by a customization file read by the web development tool when opening a particular web application. Note that the number and type of customizations described in the examples above are provided for purposes of illustration, and are not intended to be limiting. Any number and type of customizations may be provided to a GUI by definitions in a customization file.

For example, a customization file may include definitions configured to delete default UI elements. The customization file may include deletion definitions, such as “DeleteRibbonGroup” to delete a specified default ribbon group, “DeleteDashboardItem” to delete a specified default dashboard item, and/or other deletion definitions for UI elements described herein or otherwise known. Furthermore, a customization file may include definitions configured to modify default UI elements. The customization file may include modification definitions, such as “ModifyRibbonGroup” to modify a specified default ribbon group (e.g., adding, renaming, and/or removing buttons, etc.), “ModifyDashboardItem” to modify a specified default dashboard item (e.g., providing a new title, revising a description, changing a link, etc.), and/or other modification definitions for UI elements described herein or otherwise known.

### B. Example Embodiments for Generating Customization Files

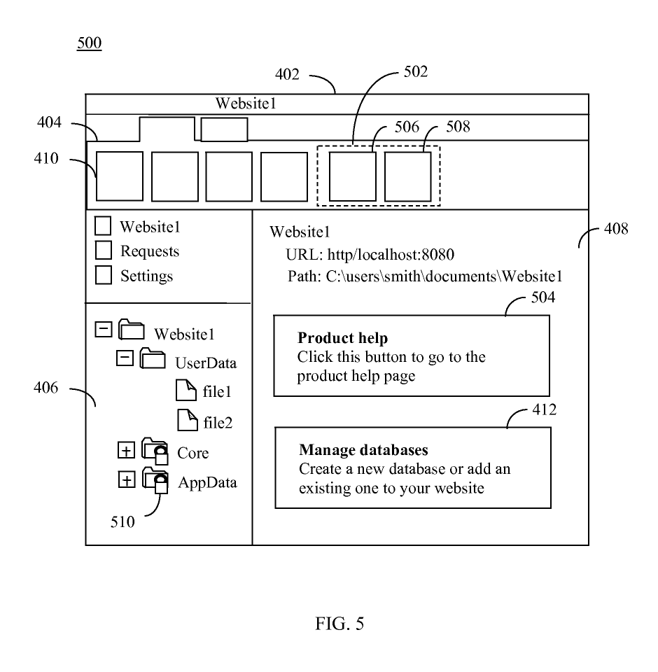

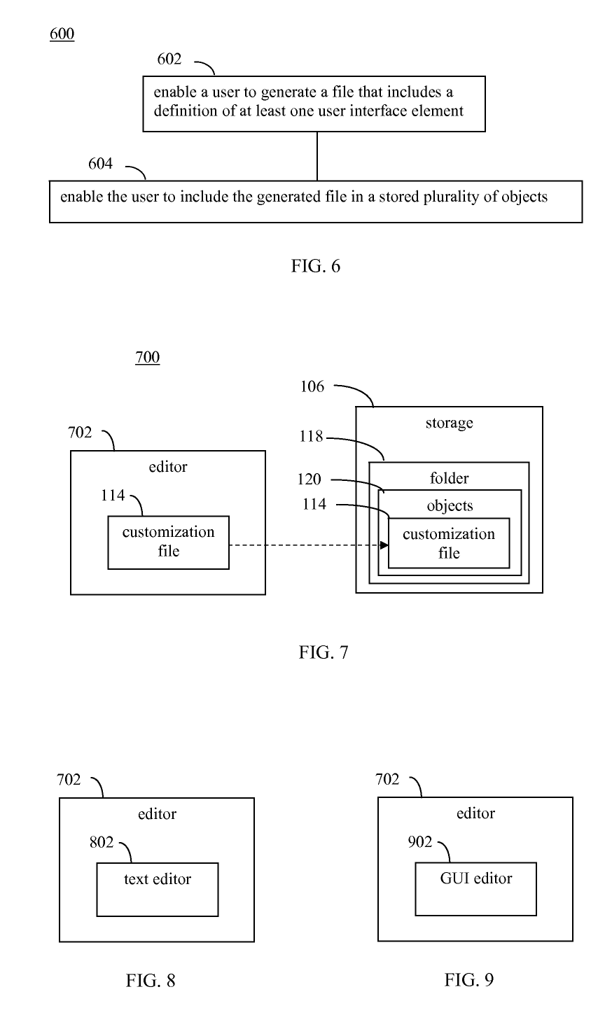

In embodiments, customization files (e.g., customization file 114 of FIG. 1, customization file 200 of FIG. 2, etc.) may be generated in various ways. For instance, FIG. 6 shows a flowchart 600 providing a process for generating a customization file to be used to customize a web development tool GUI, according to an example embodiment. In an embodiment, flowchart 600 may be performed by an editing tool that is included in or separate from web development tool 108.

For instance, FIG. 7 shows a block diagram of a customization file creation system 700, according to an example embodiment. As shown in FIG. 7, system 700 includes an editor 702 and storage 106. Flowchart 600 may be performed by editor 702 of FIG. 7 in an embodiment. Further structural and operational embodiments will be apparent to persons skilled in the relevant art(s) based on flowchart 600. For illustrative purposes, flowchart 600 is described as follows with respect to system 700 of FIG. 7.

Flowchart 600 begins with step 602. In step 602, a user is enabled to generate a file that includes a definition of at least one user interface element. For example, in an embodiment, editor 702 of FIG. 7 may be capable of enabling a user to generate customization file 114 that includes one or more user interface element definitions (e.g., a custom UI element definition 202 of FIG. 2). Editor 702 may be configured in various ways to enable customization file 114 and the included definitions to be generated.

For instance, FIGS. 8 and 9 show block diagrams of editor 702, according to example embodiments. As shown in FIG. 8, editor 702 may include a text editor 802. Text editor 802 is a tool that enables customization file 114 to be generated as a text file, and enables editing of customization file 114. Many examples of text editor 802 exist, including plain text editors (e.g., Microsoft Notepad), a word processor (e.g., Microsoft Word, Google Docs™, etc.), a textual source code editor (e.g., as provided in Microsoft Visual Studio®), and/or other type of text editor 802. Text editor 802 may enable a user to enter one or more custom UI element definitions in any format, including plain text, a markup language or other programming language, or other form. As shown in FIG. 9, in another embodiment, editor 702 may include a GUI editor 902. GUI editor 902 is a tool that enables generation and editing of customization file 114 using a graphical user interface. For instance, GUI editor 902 may optionally provide definition templates (e.g., a ribbon template, a menu template, a button template, etc.) that are templates of code that may be selected and filled in by a user to generate specific custom UI element definitions.

In step 604, the user is enabled to include the generated file in a stored plurality of objects. For example, as shown in FIG. 7, editor 702 enables a user to save/store customization file 114 in folder 118 with objects 120 of a web application. For instance, editor 702 may provide a navigation tool that enables the user to navigate through directories in storage 106 to folder 118, and to save customization file 114 in folder 118. In this manner, a web development tool may detect the presence of customization file 114 when operating on the web application, and may thereby provide the customizations defined by customization file 114 to a GUI of the web development tool.

### C. Example Embodiments for Generating Customized GUIs

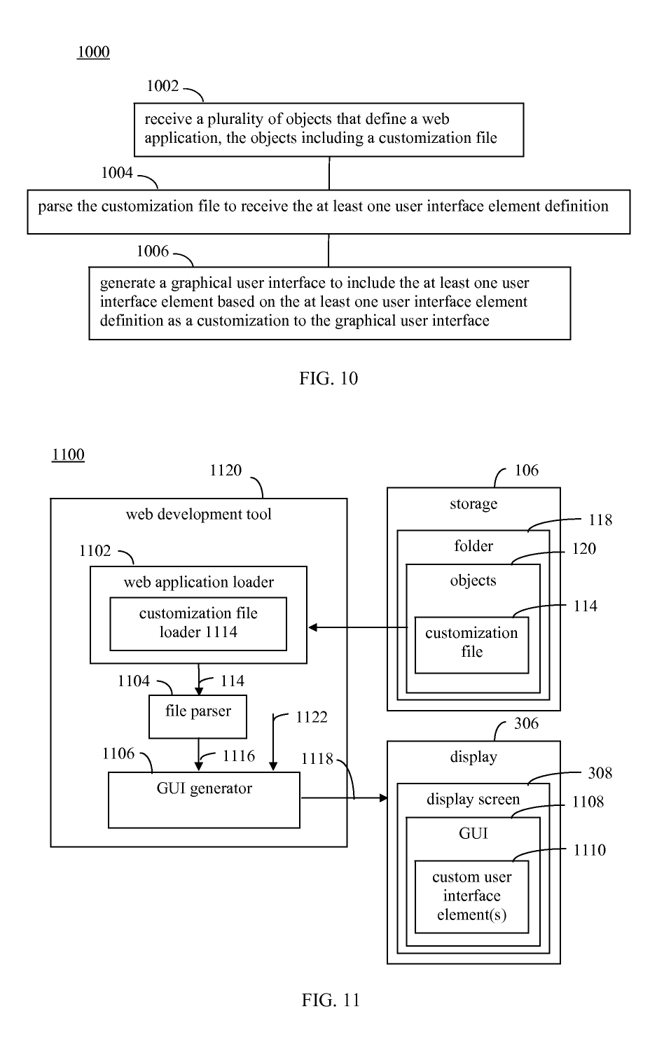

In embodiments, customized GUIs, such as GUI 500 of FIG. 5, may be generated by web development tools for web applications in various ways. For instance, FIG. 10 shows a flowchart 1000 providing a process for generating a customized web development tool GUI, according to an example embodiment. In an embodiment, flowchart 1000 may be performed by web development tool 108 of FIG. 1. For purposes of illustration, flowchart 1000 is described with respect to FIG. 11. FIG. 11 shows a block diagram of a GUI customization system 1100, according to an example embodiment. As shown in FIG. 11, system 1100 includes a web development tool 1120, storage 106, and display 306. Furthermore, web development tool 1120 includes a web application loader 1102, a file parser 1104, and a GUI generator 1106. Web development tool 1120 is an example embodiment of web development tool 108. Further structural and operational embodiments will be apparent to persons skilled in the relevant art(s) based on the following description.

Flowchart 1000 begins with step 1002. In step 1002, a plurality of objects is received that define a web application, the objects including a customization file. For example, as shown in FIG. 11, web application loader 1102 may access folder 118 in storage 106, and receive/open one or more of objects 120. For instance, in an embodiment, web application loader 1102 may include a file/directory navigator. A user may interact with a user interface of web development tool 1120 (e.g., a GUI 1108 displayed by display screen 308 of display 306) to navigate to objects 120 in folder 118 of storage 106. In another embodiment, web application loader 1102 may download objects 120 for a web application from a remote server or other location. In still another embodiment, web application loader 1102 may access or be provided with a link (e.g., a URL) to the web application. Web application loader 1102 may traverse the link to receive objects 120. In an embodiment, folder 118 may be compressed (e.g., a zip file containing objects 120 in compressed form, or other compressed file type) or may be uncompressed. When folder 118 is compressed, web application loader 1102 may decompress folder 118 and its contents when opening of folder 118 according to step 1002. Note that web application loader 1102 may be configured to access objects corresponding to a web application in another way (e.g., stored in “project” form, etc.).

As described above, objects 120 define a web application. Furthermore, as described above, customization file 114 may be present in objects 120. For example, customization file 114 may have been placed in folder 118 as described above with respect to FIGS. 6-9 or in another manner. In an embodiment, as shown in FIG. 11, web application loader 1102 may include a customization file loader 1114. Customization file loader 1114 may be configured to search folder 118 of a web application for the presence of customization file 114. For instance, customization file loader 1114 may be able to detect the presence of customization file 114 by a predetermined file name for customization file 114, by analyzing data in a predetermined field (e.g., a field in a header, etc.) of customization file 114, by a predetermined file extension, or in other manner. When customization file loader 1114 detects customization file 114 in folder 118, customization file loader 1114 is configured to load customization file 114.

In step 1004, the customization file is parsed to receive the at least one user interface element definition. As shown in FIG. 11, web application loader 1102 may output customization file 114, which is received by file parser 1104. In an embodiment, file parser 1104 is configured to parse customization file 114 to extract each custom UI element definition (e.g., each custom UI element definition 202 shown in FIG. 2) included therein. As shown in FIG. 11, file parser 1104 outputs one or more custom UI element definitions 1116. For instance, one or more custom UI element definitions 1116 may include each the block of text or code (e.g., markup language, program code, etc.) corresponding to each custom UI element definition (e.g., custom UI element definitions 202 of FIG. 2).

In step 1006, a graphical user interface is generated to include the at least one user interface element based on the at least one user interface element definition as a customization to the graphical user interface. For example, as shown in FIG. 11, GUI generator 1106 receives custom UI element definition(s) 1116. In an embodiment, GUI generator 1106 is configured to generate GUI display information 1118. GUI display information 1118 includes graphical information that may be received by display 306 to generate (e.g., render) a display of GUI 1108 on display screen 308. GUI generator 1106 includes graphical information in GUI display information 1118 corresponding to default UI elements to be included in GUI 1108. Furthermore, GUI generator 1106 includes graphical information in GUI display information 1118 corresponding to custom UI elements to be included in GUI 1108 based on custom UI element definition(s) 1116. As shown in FIG. 11, GUI 1108 includes custom user interface element(s) 1110, which are displayed based on custom UI element definition(s) 1116.

For instance, in an embodiment, GUI generator 1106 may receive default UI information 1122, which includes information to enable GUI 1108 to be displayed without customization. GUI generator 1106 may process default UI information 1122 with each custom user interface element definition indicated in custom user interface element(s) 1110 (e.g., in a serial or parallel fashion) to modify the default GUI with the corresponding customizations. For instance, GUI generator 1106 may perform a custom UI element definition/task (e.g., execute the definition code, etc.) to modify the default GUI accordingly. In this manner, custom user interface element(s) 1110 may be displayed in GUI 1108. Examples of custom user interface element(s) 1110 are described above, including first-fourth custom UI elements 304a-304d, ribbon group element 502, dashboard item element 504, graphical UI protection elements 510, etc.

In this manner, web development tool 1120 may customize GUI 1108 with custom user interface element(s) 1110. Furthermore, each time that web development tool 1120 is used to operate on the web application corresponding to objects 120, web development tool 1120 (e.g., customization file loader 1114) may determine whether customization file 114 is present, and if so, may perform the indicated customizations. Customization file 114 may be modified (e.g., by editor 702 of FIG. 7) at any time. If customization file 114 is modified subsequent to the web application being operated on by web development tool 1120, the next time web development tool 1120 is invoked on the web application after the modifications, the modified form of customization file 114 is loaded. In this manner, different custom UI elements may be provided at different times that web development tool 1120 operates on the web application, including different added custom UI elements, different deletions of default UI elements, and/or different modifications to default UI elements.

### III. Example Computing Device Embodiments

Web development tool 108, editor 702, text editor 802, GUI editor 902, web development tool 1120, web application loader 1102, file parser 1104, GUI generator 1106, flowchart 600, and flowchart 1000 may be implemented in hardware, software, firmware, or any combination thereof. For example, web development tool 108, editor 702, text editor 802, GUI editor 902, web development tool 1120, web application loader 1102, file parser 1104, GUI generator 1106, flowchart 600, and/or flowchart 1000 may be implemented as computer program code configured to be executed in one or more processors. Alternatively, web development tool 108, editor 702, text editor 802, GUI editor 902, web development tool 1120, web application loader 1102, file parser 1104, GUI generator 1106, flowchart 600, and/or flowchart 1000 may be implemented as hardware logic/electrical circuitry. For instance, in an embodiment, one or more of web development tool 108, editor 702, text editor 802, GUI editor 902, web development tool 1120, web application loader 1102, file parser 1104, GUI generator 1106, flowchart 600, and/or flowchart 1000 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

As described above, web development tool 108 may generate one or more user interfaces. For instance, web development tool 108 may enable user input to be provided from one or more of any type of user interface elements provided by computing device 102, including a keyboard, a thumb wheel, a pointing device, a roller ball, a stick pointer, a touch sensitive display, any number of virtual interface elements, a voice recognition system, etc.

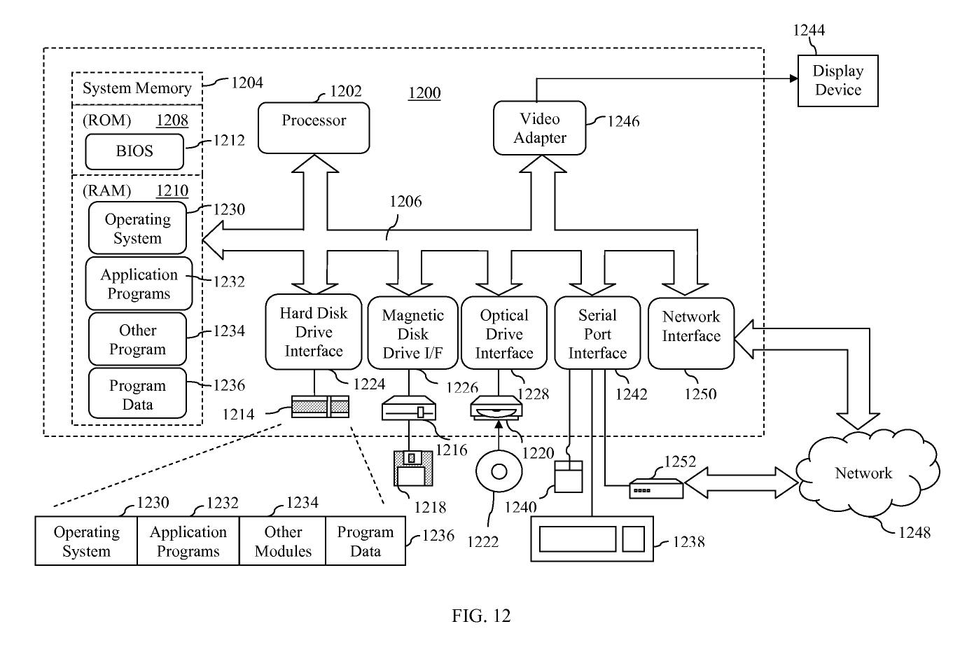

FIG. 12 depicts an exemplary implementation of a computer 1200 in which embodiments of the present invention may be implemented. For example, computing device 102 and/or publication server 104 may be implemented in a computer system similar to computer 1200, including one or more features of computer 1200 and/or alternative features. Computer 1200 may be a general-purpose computing device in the form of a conventional personal computer, a mobile computer, a server, or a workstation, for example, or computer 1200 may be a special purpose computing device. The description of computer 1200 provided herein is provided for purposes of illustration, and is not intended to be limiting. Embodiments of the present invention may be implemented in further types of computer systems, as would be known to persons skilled in the relevant art(s).

As shown in FIG. 12, computer 1200 includes one or more processors 1202, a system memory 1204, and a bus 1206 that couples various system components including system memory 1204 to processor 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic for implementing web development tool 108, editor 702, text editor 802, GUI editor 902, web development tool 1120, web application loader 1102, file parser 1104, GUI generator 1106, flowchart 600, and/or flowchart 1000 (including any step of flowcharts 600 and 1000), and/or further embodiments described herein.

A user may enter commands and information into the computer 1200 through input devices such as keyboard 1238 and pointing device 1240. Other input devices (not shown) may include a microphone, joystick, game pad, satellite dish, scanner, or the like. These and other input devices are often connected to processor 1202 through a serial port interface 1242 that is coupled to bus 1206, but may be connected by other interfaces, such as a parallel port, game port, or a universal serial bus (USB).

A display device 1244 is also connected to bus 1206 via an interface, such as a video adapter 1246. In addition to the monitor, computer 1200 may include other peripheral output devices (not shown) such as speakers and printers.

Computer 1200 is connected to a network 1248 (e.g., the Internet) through an adaptor or network interface 1250, a modem 1252, or other means for establishing communications over the network. Modem 1252, which may be internal or external, is connected to bus 1206 via serial port interface 1242.

As used herein, the terms “computer program medium,” “computer-readable medium,” and “computer-readable storage medium” are used to generally refer to media such as the hard disk associated with hard disk drive 1214, removable magnetic disk 1218, removable optical disk 1222, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250 or serial port interface 1242. Such computer programs, when executed or loaded by an application, enable computer 1200 to implement features of embodiments of the present invention discussed herein. Accordingly, such computer programs represent controllers of the computer 1200.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a computing device, comprising:
enabling a user to generate an object that includes a definition of at least one user interface element; and
enabling the user to include the generated object in a stored plurality of objects, the objects configured to be loaded and installed by a web development tool as an instance of a web application;
the object configured to be read by the web development tool to display the at least one user interface element as a customization to a graphical user interface displayed by the web development tool, the graphical user interface configured to be interacted with to enable the web application to be developed.

2. The method of claim 1, wherein said enabling a user to generate an object comprises:
enabling the user to configure the definition of the at least one user interface element using a markup language.

3. The method of claim 2, wherein said enabling a user to generate an object comprises:
enabling the user to generate the object as an XML (extensible markup language) document that includes the definition of the at least one user interface element in the form of XML code.

4. The method of claim 1, wherein said enabling a user to generate an object comprises:
providing a text editor to enable the user to edit the object.

5. The method of claim 1, wherein said enabling a user to generate an object comprises:
providing a graphical user interface to enable the user to configure the definition of the at least one user interface element in the object.

6. The method of claim 1, wherein said enabling a user to generate an object comprises:
enabling the user to provide a user interface element definition of at least one of a button, a link, a navigation element, or a file copy element; and
enabling the user to include an action with the user interface element definition.

7. The method of claim 1, wherein said enabling a user to generate an object comprises:
enabling the user to include at least one of a name or a textual description for an associated user interface element in a user interface element definition.

8. A method in a web development tool, comprising:
receiving a plurality of objects that define a web application;
determining that the objects include a customization object that includes a definition for at least one user interface element as a customization to a graphical user interface;
parsing the customization object to receive the at least one user interface element definition; and
generating a graphical user interface for display that is configured to be interacted with by a user to enable the web application to be developed, said generating including
generating the graphical user interface to include the at least one user interface element based on the at least one user interface element definition as a customization to the graphical user interface.

9. The method of claim 8, wherein the customization object is a document that contains the at least one user interface element in the form of a markup language, wherein said parsing the customization object comprises:
parsing the document to receive the at least one user interface element definition configured in the form of the markup language.

10. The method of claim 8, wherein the customization object is an XML (extensible markup language) document that includes the definition of the at least one user interface element in the form of XML code, wherein said parsing the customization object comprises:
parsing the document to receive the XML code corresponding to the at least one user interface element definition.

11. The method of claim 8, wherein said generating the graphical user interface to include the at least one user interface element based on the at least one user interface element definition as a customization to the graphical user interface comprises:
displaying at least one of a button, a link, a navigation element, or a file copy element as the at least one user interface element.

12. The method of claim 8, wherein the at least one user interface element includes a first user interface element, the method further comprising:
associating an action defined in the at least one user interface element definition with the first user interface element to be performed if a user interacts with the first user interface element.

13. The method of claim 8, wherein said generating the graphical user interface to include the at least one user interface element based on the at least one user interface element definition as a customization to the graphical user interface comprises:
displaying at least one of a name or a textual description defined in the at least one user interface element definition for an associated user interface element.

14. A web development tool in a computing device, comprising:
a loader configured to access a plurality of objects that define a web application, the loader further including a customization object loader configured to load a customization object that includes a definition for at least one user interface element as a customization to a graphical user interface if the objects include the customization object;
a file parser configured to parse the customization object to receive the at least one user interface element definition; and
a GUI (graphical user interface) generator configured to generate a graphical user interface for display that is configured to be interacted with by a user to enable the web application to be developed, the GUI generator including the at least one user interface element in the graphical user interface based on the at least one user interface element definition as a customization to the graphical user interface.

15. The web development tool of claim 14, wherein the customization object is a document that contains the at least one user interface element in the form of a markup language, wherein the file parser parses the document to receive the at least one user interface element definition configured in the form of the markup language.

16. The web development tool of claim 14, wherein the customization object is an XML (extensible markup language) document that includes the definition of the at least one user interface element in the form of XML code, wherein the parser parses the document to receive the XML code corresponding to the at least one user interface element definition.

17. The web development tool of claim 14, wherein the GUI generator is configured to display at least one of a button, a link, a navigation element, or a file copy element as the at least one user interface element based on the at least one user interface element definition.

18. The web development tool of claim 14, wherein the at least one user interface element includes a first user interface element, wherein the GUI generator is configured to associate an action defined in the at least one user interface element definition with the first user interface element to be performed if a user interacts with the first user interface element.

19. The web development tool of claim 14, wherein the GUI generator is configured to display at least one of a name or a textual description defined in the at least one user interface element definition for an associated user interface element.
